(19) United States
(12) Patent Application Publication
(10) Pub. No.: US 2009/0308363 A1
(43) Pub. Date: Dec. 17, 2009

(54) EXHAUST GAS RECIRCULATION DEVICE AND VEHICLE PROVIDED WITH THE SAME

(75) Inventor: Stefan HOFFMANN, Russelsheim (DE)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR); Hyundai Motor Europe Technical Center GmbH, Russelsheim (DE)

(21) Appl. No.: 12/253,020

(22) Filed: Oct. 16, 2008

(30) Foreign Application Priority Data
Jun. 12, 2008 (EP) 08158084.7

(51) Int. Cl. F02M 25/07; F02B 47/08

(52) U.S. Cl. 123/568.12

(57) ABSTRACT

An exhaust gas recirculation device for an internal combustion engine, a controllable exhaust gas recirculation valve for controlling an exhaust gas flow of the internal combustion engine, an exhaust gas cooler for cooling the exhaust gas flow, and a bypass device which has a bypass pipe arranged parallel with the exhaust gas cooler, by means of which pipe the exhaust gas flow can be fed at least partially past the exhaust gas cooler, and which has a controllable bypass switch which is arranged inside a valve housing of the exhaust gas recirculation valve. The invention also relates to a vehicle.

### CROSS-REFERENCE TO RELATED APPLICATION

This application claims priority to and the benefit of European Patent Application No. 08158084.7 filed in the European Patent Office on Jun. 12, 2008, the entire contents of which are incorporated herein by reference.

### BACKGROUND OF THE INVENTION

(a) Field of the Invention

The invention relates to an exhaust gas recirculation device for an internal combustion engine and a vehicle provided with the same. More particularly, this invention relates to the exhaust gas recirculation (EGR) in internal combustion engines and combustion engines. Derived from the English “Exhaust Gas Recirculation”, EGR is often used synonymously with the German AGR in the area of exhaust gas recirculation.

(b) Description of the Related Art

At very high combustion temperatures in a combustion engine, such as an Otto engine, a diesel engine, a gas turbine and the like, the nitrogen (N) contained in the air is combined with the oxygen (O), and toxic nitrogen oxides (NOx) are formed. The exhaust gas recirculation is used for reducing these nitrogen oxides in order to adhere to the legally prescribed toxin emission limits, particularly in modern motor vehicles. In exhaust gas recirculation at least a proportion of the exhaust gas generated by the combustion engine is returned to the intake section for the purpose of reducing the NOx emissions and mixed with the fresh air supplied to the combustion engine. The mixture formed from fresh air and exhaust gas has a lower oxygen content and hence also a lower calorific value relative to the total volume. This means that the high temperatures in the combustion chamber of the combustion engine required for the NOx formation are no longer reached, giving rise to less nitrogen oxides. Moreover, the exhaust gas recirculation is used deliberately to reduce the specific fuel consumption in the partial load region of combustion engines.

In exhaust gas recirculation, the exhaust gas is added to the fresh air by means of a pipe return line in which a so-called exhaust gas recirculation valve is arranged. The exhaust recirculation valve is an adjustable valve which creates a flow connection between the exhaust section and the intake section of the combustion engine and the exhaust gas flow in the exhaust gas recirculation pipe.

To achieve an even better reduction in the nitrogen oxides, the hot exhaust gas generated by the combustion engine, particularly in high performance engines, is cooled by means of a so-called exhaust gas recirculation cooler before it is added to the fresh air.

The disadvantage of this method is the increased formation of carbon monoxides and unburned hydrocarbons during the combustion process if, for example, the fresh air-exhaust gas mixture supplied to the combustion engine is too cold. For this reason the exhaust gas recirculation cooler is at least partially bridged to reduce the cooling effect of the recirculated exhaust gas, if the combustion engine is still cold.

FIG. 1 shows an exhaust recirculation system described in U.S. Pat. No. 4,147,141, for example, with such exhaust recirculation cooling. Here an EGR pipe 1 is provided which serves to connect exhaust side 2 of a combustion engine to its intake section 3. An EGR cooler 4 is provided along this EGR pipe 1 for cooling the exhaust gas, and a bypass pipe 5 is provided parallel with EGR cooler 4. Furthermore, a selection valve 6 is provided for controlling the exhaust gas flow, which valve is connected in series to the ER cooler 4 and the bypass pipe 5. The EGR system also comprises an EGR valve 7, arranged on EGR pipe 1, for controlling the total exhaust gas flow in EGR pipe 1. The EGR system operates such that exhaust gas from the combustion engine is bypassed around EGR cooler 4 at low exhaust gas temperatures. At high exhaust gas temperatures the exhaust gas is fed by means of selection valve 6 through EGR cooler 4 so that it can cool there.

The problem with this solution, however, is that two valves are required here in the EGR pipe, i.e. on the one hand an EGR valve 7 for exhaust gas control purposes, and on the other hand a section valve 6 for controlling the bypass function. This is not only cost-intensive, because two separate components are supplied here, which are also mounted in the EGR by separate assembly methods, but corresponding interruptions in the EGR pipe are also required because of the installation of the two valves, presenting an increased risk of wear. In particular, however, increased construction space is required in the engine due to the installation of the two valves arranged in two different locations in the exhaust gas recirculation system. In modern motor vehicles, however, there is always a demand for a highly compact and space-saving arrangement of the parts installed in the engine compartment due to the naturally very limited space available.

The above information disclosed in this Background section is only for enhancement of understanding of the background of the invention and therefore it may contain information that does not form the prior art that is already known in this country to a person of ordinary skill in the art.

### SUMMARY OF THE INVENTION

In the light of this the object of this invention is to provide a simplified exhaust gas recirculation device.

According to exemplary embodiments of the invention, an exhaust gas recirculation device for an internal combustion engine, including a controllable exhaust gas recirculation valve controlling an exhaust gas flow of the internal combustion engine, an exhaust gas cooler connected to the controllable exhaust gas recirculation valve and cooling the exhaust gas flow; and a bypass device, which has a bypass pipe arranged substantially in parallel to the exhaust gas cooler, wherein a part of the exhaust gas flow can be fed into a downstream portion of the exhaust gas cooler through the bypass pipe, and wherein the controllable exhaust gas recirculation valve further comprises a controllable bypass switch which is arranged inside a valve housing of the exhaust gas recirculation valve.

A vehicle comprising an internal combustion engine which has an exhaust outlet and a fresh air intake, and an exhaust gas recirculation device according to an exemplary embodiment of the present invention, which is connected on the exhaust side to the exhaust outlet and on the fresh air side to the fresh air intake, and which is configured to add exhaust gas from the exhaust outlet to the fresh air at the fresh air intake.

The exhaust gas recirculation valve normally has a closed position and an at least partially open position. In the closed position no exhaust gas flows via the exhaust gas recirculation valve, whilst in the open position more or less exhaust gas is able to flow via the exhaust gas recirculation valve to the fresh air side of the internal combustion engine, depending on the opening. The bypass switch, on the other hand, has a first open position in which exhaust gas only flows through the exhaust gas recirculation cooler. In addition a mixed form of these two open positions is also possible, the exhaust gas flowing both through the bypass pipe and the exhaust gas cooler. According to exemplary embodiments of the invention these functions are now replaced, in terms of the opening and closing functions, by a single exhaust recirculation valve with an integrated bypass switch. This component, which is also described in the following as a functionally extended exhaust gas recirculation valve, now performs the function of a conventional exhaust gas recirculation valve and also the function of a selection switch or selection valve for selecting the bypass function.

The particular advantage of this invention now consists in supplying a single component for both these functions, which therefore brings cost advantage in implementing the exhaust gas recirculation. These cost advantages result, in particular, from the smaller number of components required for this and the lower cost of installing these components in the exhaust recirculation pipe. Weight advantages are also achieved.

Because the number of components in the exhaust gas recirculation pipe is reduced, this also provides an additional degree of freedom for the designer of the combustion chamber of a motor vehicle, since only a single part with two functions need now be installed in the exhaust gas recirculation pipe, whilst previously two parts had to be supplied for these two functions.

Because of the reduction in the number of components there is also, advantageously, a reduction in the construction space required in the engine compartment of a motor vehicle, which is then available for other elements in the engine compartment of a motor vehicle.

In an embodiment of the invention at least one exhaust gas recirculation pipe is provided in which are arranged the functionally extended exhaust gas recirculation valve and the exhaust gas cooler, one behind the other. “Arranged in the pipe” means, in this context, that the pipe is interrupted at the pipe section in which are arranged the exhaust gas recirculation valve and the exhaust gas cooler, and are connected to the pipe section by suitable connection means, e.g. flanges. Here the exhaust gas is first able to flow through the exhaust gas recirculation valve, then flow via the exhaust gas cooler and the corresponding bypass device. Of course, it would also be conceivable for the exhaust gas first to flow via the exhaust gas cooler and the parallel bypass device and only then be fed via the exhaust gas recirculation valve to the intake section of the internal combustion engine. The arrangement of the exhaust gas recirculation valve, related to the exhaust gas cooler, depends on the requirements imposed and the conditions inside the engine compartment.

In a preferred embodiment, however, the exhaust gas cooler is arranged downstream from the functionally extended exhaust gas recirculation valve, i.e. the hot exhaust gas first flows via the exhaust gas recirculation valve and only then through the exhaust gas cooler. The exhaust gas recirculation valve has a valve housing with at least one exhaust intake and at least one exhaust outlet, the bypass switch being arranged in the above-mentioned case inside the valve housing and, in particular, provided in the region of its exhaust outlet, to which the bypass pipe is also connected. Here the valve housing preferably has two exhaust outlets, a first exhaust outlet being connected to the exhaust gas cooler and a second to the bypass pipe.

In a preferred embodiment the bypass switch is designed as a mechanical switch in the form of a single bypass valve which is controllable by means of a control device. It would of course also be conceivable for the bypass switch function to be performed in the form of a bypass valve, throttle or the like.

In a preferred development of the invention the function of the inventive exhaust recirculation valve is performed by a single controllable, mechanical switch. This mechanical switch is arranged in the valve housing of the exhaust gas recirculation valve. This mechanical switch is controllably designed here so that the exhaust gas flows at least partially via the bypass pipe in a first open position, and so that the exhaust gas flows at least partially through the exhaust gas cooler in a second open position. In addition, a closing position can also be provided in which the exhaust gas flows neither through the bypass pipe nor through the bypass cooler. This closing position corresponds here to the function of an exhaust gas recirculation valve of prior art, in which only the exhaust flow is varied by opening and closing.

In a preferred embodiment an actuator is provided for the mechanical actuation of the exhaust gas recirculation valve and the bypass switch. This actuator is provided in or directly on the housing of the exhaust gas recirculation valve. By suitable activation of the control device the actuator is able to actuate the exhaust gas recirculation valve, i.e. open and close it, and hence vary the flow cross-section in the exhaust gas recirculation pipe.

In a preferred embodiment the actuator has at least one spring element for actuating the exhaust gas recirculation valve and/or the bypass switch. The actuator is coupled by the at least one spring element to the bypass switch, by spring resilience, so that the bypass switch can be brought by spring resilience into the first open position, into the second open position and/or into the closing position.

In a particularly preferred embodiment a single control device is provided which controls both the function of the exhaust recirculation valve and the function of the bypass valve. The exhaust gas recirculation valve requires in any case a control device which is now also used for controlling the bypass switch.

In a preferred embodiment an electronic control device is provided which is preferably implemented in the engine control system. This electronic control device is able to control the functions of the exhaust gas recirculation valve and those of the bypass switch by means of electrical control signals. These elements, i.e. the exhaust gas recirculation valve and the bypass switch, are then adjusted on the basis of the electrical control signals by means of mechanical, pneumatic, hydraulic or piezoelectric actuators. The electronic control device generates preferably PWM (Pulse Width Modulation) control signals for controlling both the function of the exhaust recirculation valve and the bypass switch. Of course another modulation of the control signals, e.g. an amplitude modulation (ASK), frequency modulation (FSK) and the like would also be possible.

In an alternative embodiment to this a purely mechanical control device is provided. This mechanical control device is designed to control the functions of the exhaust recirculation valve and/or the bypass switch, preferably by adjustable camshafts. This design is particularly advantageous for a so-called internal exhaust gas recirculation in which the exhaust gas is fed directly to the intake section inside the housing of the engine block or at least close to it. Of course a corresponding mechanical actuation would also be conceivable in the case of a so-called external exhaust recirculation, although this is more expensive.

In a preferred embodiment the exhaust recirculation device is connected directly to an exhaust manifold of the engine block of the vehicle on the exhaust side, and to a common fresh air pipe on the fresh air side, connected downstream to the intake manifold of the engine block.

### BRIEF DESCRIPTION OF THE DRAWINGS

FIG. 1 shows a diagrammatic structure of an exhaust gas recirculation device of prior art.

FIG. 2 shows a diagrammatic representation of an exhaust gas recirculation device according to a first exemplary embodiment of the present invention.

FIGS. 3a-3c show diagrammatic representations of an integrated bypass switch device at different operating conditions in an exhaust recirculation valve according to a first exemplary embodiment of the present invention.

FIG. 4 shows a diagrammatic representation of an exhaust recirculation valve according to a second exemplary embodiment of the present invention.

FIGS. 5a, 5b show diagrammatic representations of an exhaust gas recirculation valve according to a third exemplary embodiment of the present invention. [0032] FIG. 6 shows a diagrammatic representation of a second exemplary embodiment of an exhaust recirculation device according to the present invention.

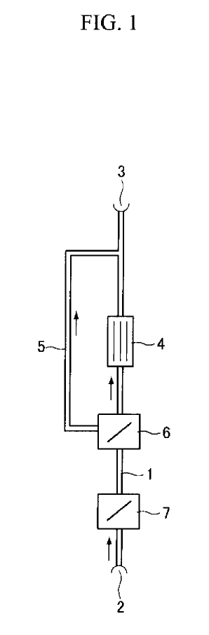

### DETAILED DESCRIPTION OF THE EMBODIMENTS

An exemplary embodiment of the present invention will hereinafter be described in detail with reference to the accompanying drawings.

In the figures of the drawing the same and functionally similar elements, features and signals have been denoted by the same reference symbols unless otherwise shown.

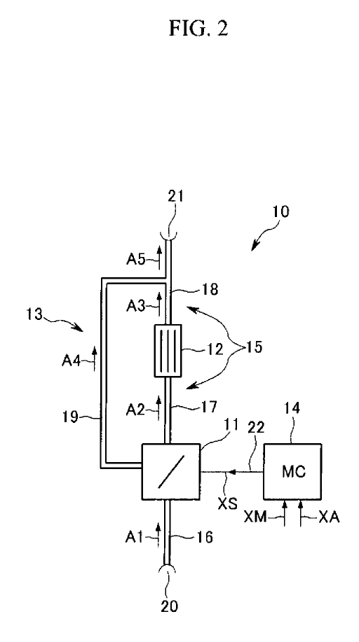

FIG. 2 shows a diagrammatic representation of an exhaust gas recirculation device according to an exemplary embodiment of the present invention.

In FIG. 2 the exhaust recirculation system is denoted by reference symbol 10. The exhaust gas recirculation system 10 comprises a controllable exhaust gas recirculation valve 11, an exhaust gas cooler 12, a bypass device 13 and a control device 14. Exhaust gas recirculation system 10 also comprises an exhaust gas recirculation pipe 15 which has a plurality of pipe sections 16-19. In the exemplary embodiment shown exhaust recirculation valve 11 is arranged upstream from exhaust gas cooler 12 in exhaust gas recirculation pipe 15. Exhaust gas recirculation valve 11 is therefore connected on the intake side by a first pipe section 16 to exhaust intake 20, and is connected on the outlet side by a second pipe section 17 to exhaust gas cooler 12. Exhaust gas cooler 12 is connected on the outlet side by a third pipe section 18 to exhaust outlet 21. Bypass device 13 comprises a bypass pipe 19, which is arranged parallel with exhaust gas cooler 12. This bypass pipe 19 therefore branches off from exhaust gas recirculation valve 11, and runs downstream of exhaust gas cooler 12 into the third pipe section 18.

In FIG. 2 the exhaust gas flows flowing into the respective pipe sections 16 to 19 are denoted by reference symbols A1-A5.

Furthermore exhaust recirculation valve 11 is also connected by a control pipe 22 to control device 14. This control device 14 may, for example, be designed as an external control device. For example, it can be implemented in the engine control system of the vehicle. Control device 14 is arranged, for example, in a microcontroller. Control device 14 typically receives exhaust gas measuring signals XA, which receive information on the exhaust gas flows A1-A5 flowing in the different pipe sections 16-19. Control device 14 also receives signals XM, which transmit to it information on the condition of the combustion engine. Depending on this information XA, XM, control device 14 generates control signals XS for controlling exhaust gas recirculation valve 11.

The mode of operation of exhaust gas recirculation device 10 is explained briefly in the following:

Exhaust gas cooler 12 is provided for cooling exhaust gas A2 supplied to it on the intake side. Gas cooler 12 generates on the outlet side an exhaust gas flow A3 cooled against exhaust gas flow supplied A2. This cooled exhaust gas flow A3 is added as exhaust gas flow A5 via exhaust outlet 21 to the fresh air, which is then fed to the internal combustion engine via the intake section. To prevent exhaust gas A5 added to the fresh air from becoming too cold, exhaust gas A4 can be fed (at least partially) past the exhaust gas cooler 12 via bypass pipe 19. Mixed forms, in which some of exhaust gas A1 flows through exhaust gas cooler 12 and some of exhaust gas A1 flows through bypass pipe 19, would also be conceivable.

For the functions just described, exhaust gas recirculation valve 11 has a first opening position in which exhaust gas A1 flows (at least partially) through exhaust gas cooler 12. Furthermore, a second open position of exhaust gas valve 11 is provided in which exhaust gas A4 flows (at least partially) through bypass pipe 19. In both cases exhaust gas A1 supplied on the intake side via exhaust intake 20 is fed through exhaust gas recirculation valve 11.

Exhaust gas recirculation valve 11 also has a closing position in which exhaust gas A1 present on the intake side is not fed through exhaust recirculation valve 11.

In addition, exhaust gas recirculation valve 11 is also designed to limit exhaust gas flow A1 in a controlled fashion via control device 14, dependent on the respective requirements. Exhaust gas recirculation valve 11 therefore acts to a certain extent as a throttle.

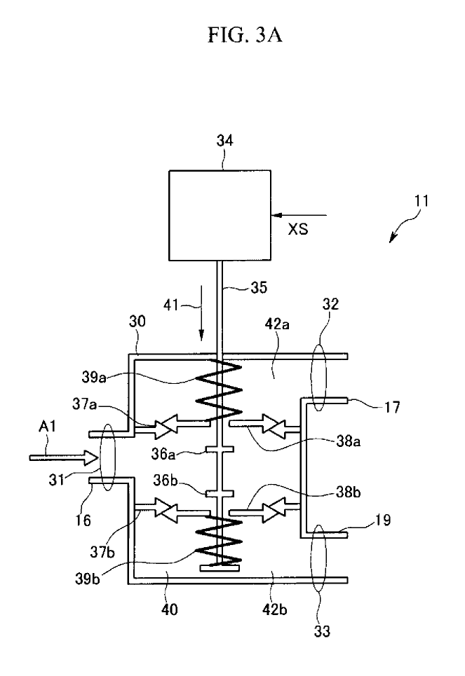

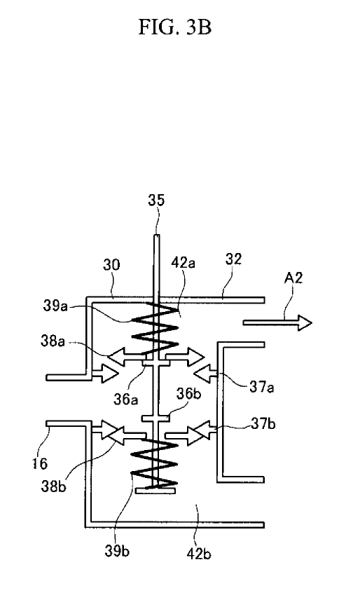

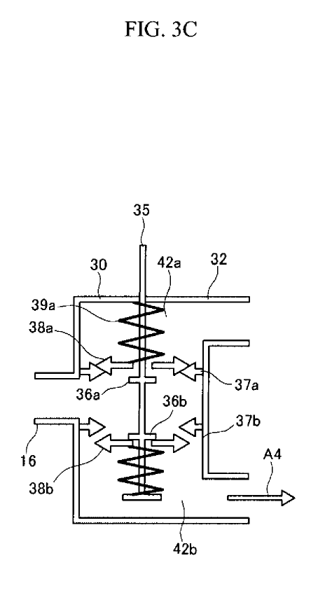

FIGS. 3a-3c show diagrammatic representations of a first exemplary embodiment of an extended exhaust gas recirculation valve 11 according to an exemplary embodiment of the present invention, with integrated bypass switch. Here three different operating conditions of this exhaust gas recirculation valve 11 are shown in FIGS. 3a-3c.

Exhaust gas recirculation valve 11 has a housing 30 which in turn has an exhaust intake 31 for feeding exhaust gas flow A1, and two exhaust outlets 32,33 for discharging exhaust gas flows A2, A4. Pipe section 16 is connected to exhaust intake 31, whilst pipe sections 17 and 19 are connected to the two exhaust outlets 32, 33 respectively.

Furthermore, an actuator 34 is provided which is connected to housing 30 by means of adjusting mechanics described in greater detail in the following. Actuator 34 may, for example, be designed as a step motor which is actuated by control signal XS of control device 14. A pneumatic, hydraulic or piezoelectric actuating device would also be conceivable alternatives to actuator 34.

Actuator 34 is preferably rigidly coupled to a connecting rod 35. Connecting rod 35 is arranged at least partially in housing 30 and can be moved linearly inside housing 30 by actuator 34 between two positions, which are described in more detail in the following. Two carrier discs 36a, 36b are also fastened to connecting rod 35.

Furthermore, valve seats 37a, 37b, which are designed in the form of rotary housing projections, are provided inside housing 30. These valve seats 37a, 37b define, as also explained in the following, different opening and closing positions of exhaust gas recirculation valve 11. Axially moving valve plates 38a, 38b are also provided along axial movement direction 41 of connecting rod 35 inside exhaust recirculation valve 11. These valve plates 38a, 38b each have axial bores for connecting rod 35. These valve plates 38a, 38b are also spring loaded against housing 30, a spring 39a, 39b being provided for this purpose, arranged around connecting rod 35 and hence exerting a spring resilience in the axial direction 41 of connecting rod 35 between the respective housing wall 40 and the respective valve plate 38a, 38b. Carrier 36a, 36b, rigidly connected to connecting rod 35, is provided on the side opposing springs 39a, 39b related to valve plates 38a, 38b. In this manner valve plates 38a, 38b can be moved in axial direction 41 either by the spring resilience of the respective springs 39a, 39b or by carrier 36a, 36b, fitted to connecting rod 35, and hence by means of actuator 34 in axial direction 41. Valve seats 37a, 37b fitted to housing wall 40 act here as limit positions and therefore define respective opening and closing positions.

In FIGS. 3a-3c two carriers 36a, 36b, valve plates 38a and 38b and spring elements 39a and 39b are provided respectively, each of which are assigned to the different exhaust outlets 32, 33, which were denoted by letters (a) and (b) to distinguish them.

The mode of operation of exhaust gas recirculation valve 11 is explained in further detail below with reference to FIGS. 3a-3c.

### Closing Position:

The closing position of exhaust recirculation valve 11 is its initial position (FIG. 3a). In this position actuator 34 may be deactivated, for example, or may be in the neutral position. Here upper and lower springs 39a, 39b push the two valve plates 38a, 38b against valve seats 37a, 37b by spring resilience. Here carriers 36a, 36b have no function because they are not loaded with a force by actuator 34. In this condition exhaust gas A1 cannot flow out of exhaust gas recirculation valve 11 either via exhaust outlet 32 or exhaust outlet 33.

### First Opening Position (For the Exhaust Gas Cooler):

As shown in FIG. 3b, in this first opening position exhaust gas A1 will flow out via first exhaust outlet 32 and therefore be fed to exhaust gas cooler 32. In this case actuator 34 moves connecting rod 35 upwards against axial direction 41, as a result of which upper valve plate 38a is pushed upwards by carrier 36a against the spring resilience of upper spring element 39a. This releases a flow duct 42a, so that exhaust gas A1 is able to flow out of exhaust gas recirculation valve 11 via exhaust outlet 32.

Lower valve plate 38b cannot be opened in this case because it is still being pressed by lower spring 39b against corresponding valve seat 37b.

### Second Opening Position (For the Bypass):

In the second opening position (FIG. 3c) actuator 34 moves connecting rod 35 in axial direction 41 so that lower valve plate 38b is pushed against the spring resilience of lower spring 39b and hence releases a lower flow duct 42b. Exhaust gas A1 can therefore flow out via lower flow duct 42b and second exhaust outlet 33, and can therefore be fed past exhaust gas cooler 12 through bypass pipe 19.

In this condition upper valve plate 38a is again released because upper carrier 36a no longer loads it with a force, so that this upper valve plate 38a is again pushed against upper valve seat 37a by the spring resilience coupling to spring element 39a. This recloses upper flow duct 42a.

In the first exemplary embodiment described with reference to FIGS. 3a-3c it was assumed that no exhaust gas is able to flow through exhaust recirculation valve 11 in the closing position. It was also assumed that in the first and second opening positions the exhaust gas is able to blow fully through the first, upper flow duct 42a or through the second, lower duct 42b, the other flow duct 42a, 42b remaining closed in these opening positions.

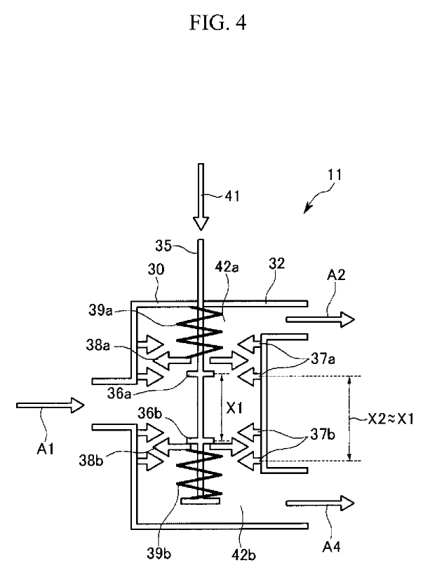

A second exemplary embodiment of an inventive exhaust gas recirculation valve 11 is explained in the following with reference to FIG. 4. Here two upper and two lower valve seats 37a, 37b are provided on each of inner housing walls 40, valve plates 38a and 38b assigned to these valve seats 37a, 37b being arranged movably between them. The two valve seats 37a, 37b therefore act as an upper and lower stopper for the respective valve plates 38a, 38b. If the two carriers 36a, 36b are installed at a mutual distance X1 on connecting rod 35, which corresponds essentially to distance X2 between the upper and lower valve seats 37a, 37b, an opening position can then be provided in this case, a position in which the exhaust gas is able to flow both through the upper and the lower flow duct 42a, 42b. In this opening condition (see FIG. 4) valve plates 38a, 38b must not stop against the corresponding valve seats 37a, 37b.

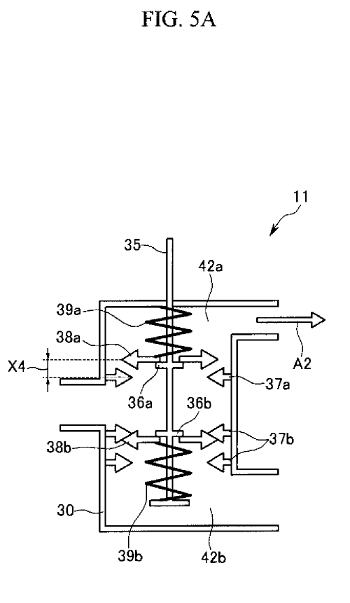

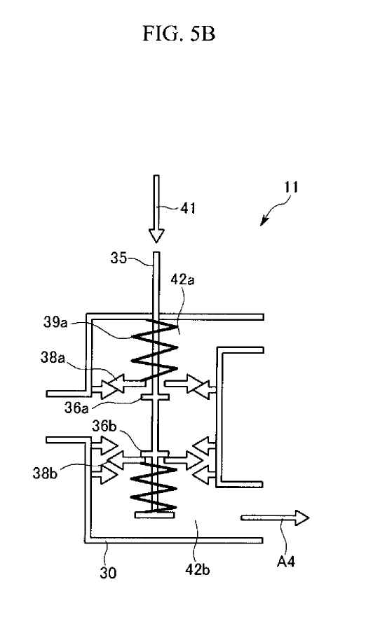

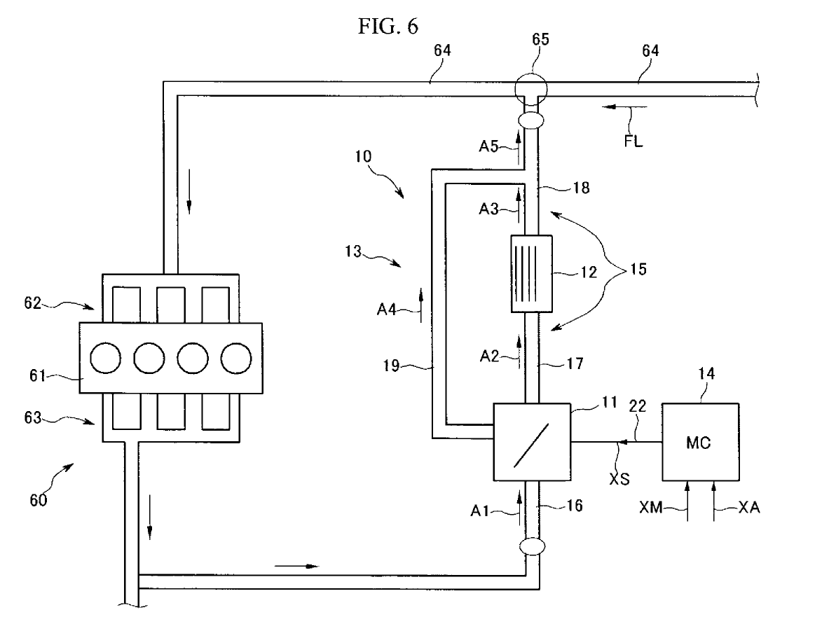

FIGS. 5a, 5b show a third exemplary embodiment of an inventive exhaust gas recirculation valve 11, in which the exhaust gas flow through bypass pipe 19 and exhaust gas cooler 12 is adjustable by means of exhaust gas recirculation valve 11. Unlike exhaust gas recirculation valve 11 shown in FIGS. 3a-3c, lower flow duct 42b here has two valve seats 37b, whilst only one valve seat 37a is provided in upper flow duct 42a. FIG. 5a shows the first opening position. Here exhaust gas flow A2 through flow duct 42a can be adjusted by stroke X4 of upper valve plate 38 relative to upper valve seat 37a. For example, the entire exhaust gas flow A1 on the intake side flows through upper flow duct 42a at a maximum stroke of valve plate 38a. Correspondingly less exhaust gas A2 then flows through upper flow duct 42a due to a correspondingly lower stroke X4. With suitable dimensioning exhaust gas flow A2 can be adjusted in this manner specifically during the first opening position by the corresponding stroke X4 of valve plate 38a.

In principle exhaust gas flow A4 through lower flow duct 42b, and hence through bypass pipe 19, could be controlled in a similar manner.

FIG. 5b shows another possibility of controlling the exhaust flow. Here lower valve plate 38b is movably displaceable between the two valve seats 37b. Here more or less exhaust gas A4 flows through the second, lower flow duct 42b and hence through bypass pipe 19 according to the position of valve plate 38b related to the respective valve seats 37b.

FIG. 6 shows a diagrammatic representation of an exemplary embodiment of an inventive exhaust recirculation device. FIG. 6 shows an internal combustion engine which is denoted by reference symbol 60. Internal combustion engine 60 has an engine block 61 with four cylinders in this case. Internal combustion engine 60 has an intake section 62 and an exhaust manifold 63. Intake section 62, which represents the fresh air side of internal combustion engine 60, is connected to a common fresh air pipe 64.

The inventive exhaust recirculation device 10 is now arranged between exhaust manifold 63 and intake section 62. Exhaust gas A1 is therefore fed directly via exhaust manifold 63 to exhaust gas recirculation device 10. Exhaust gas recirculation device 10 is connected on the outlet side by a pipe connecting piece 65 to common fresh air pipe 64. Exhaust gas A1 from exhaust manifold 63 may therefore be added by exhaust recirculation device 10 to fresh air FL in fresh air pipe 64.

Although this invention has been explained predominantly with reference to preferred exemplary embodiments, it is not limited to them but can be varied in any manner.

It is self-evident that the structural exemplary embodiments of an exhaust recirculation valve 11, described above with reference to FIGS. 3a-5b, should only be understood to be examples and can obviously be structurally modified in any manner. This relates in particular to the dimensioning of the respective valve seats, valve plates, spring elements and carrier elements and, in particular, to their relative mutual distances.

In the present exemplary embodiments it is assumed that housing 30 and exhaust gas recirculation valve 11 are designed approximately cylindrically. Valve plates 38 are therefore preferably also designed in the shape of a disc and valve seats 37 are arranged approximately annularly on housing 30. This cylindrical, circular or annular design is not absolutely necessary, however.

In particular, the exhaust gas recirculation valve need not necessarily be arranged downstream of the exhaust gas cooler but may also be provided behind it, i.e. upstream of the exhaust gas cooler.

The structural embodiments described above for implementing the closing position or the first and/or second opening position are also understood to be given only by way of example, and may be changed and modified on the basis of known knowledge, creation and skill. In particular, instead of spring-loaded valve plates, their function may also be performed in whole or at least in part by respective actuators and control elements, although the adjusting mechanics described above is extremely simple, low cost and elegant to implement.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An exhaust gas recirculation device for an internal combustion engine, comprising:
a controllable exhaust gas recirculation valve controlling an exhaust gas flow of the internal combustion engine;
an exhaust gas cooler connected to the controllable exhaust gas recirculation valve and cooling the exhaust gas flow; and
a bypass device which has a bypass pipe arranged substantially in parallel to the exhaust gas cooler,
wherein a part of the exhaust gas flow can be fed into a downstream portion of the exhaust gas cooler through the bypass pipe, and
wherein the controllable exhaust gas recirculation valve further comprises a controllable bypass switch which is arranged inside a valve housing of the exhaust gas recirculation valve.

2. The exhaust gas recirculation device according to claim 1, wherein at least one exhaust gas recirculation pipe is provided in which the exhaust gas recirculation valve and the exhaust gas cooler are arranged one behind the other.

3. The exhaust gas recirculation device according to claim 1, wherein the exhaust gas recirculation valve comprises the valve housing having at least one exhaust intake and at least one exhaust outlet, and
wherein the bypass switch is provided inside the valve housing in the region of the exhaust outlet on which the bypass pipe is also arranged.

4. The exhaust gas recirculation device according to claim 3, wherein the valve housing comprises two exhaust outlets, and
wherein a first exhaust outlet is connected to the exhaust gas cooler and a second exhaust outlet is connected to the bypass pipe.

5. The exhaust recirculation device according to claim 1,
wherein the bypass switch is selected from the group consisting of a bypass flap, a bypass valve and a bypass throttle.

6. The exhaust gas recirculation device according to claim 1, wherein the exhaust gas recirculation valve and the bypass switch are controlled by a single controllable, mechanical switch which is arranged in the valve housing of the exhaust recirculation valve.

7. The exhaust gas recirculation device according to claim 6, wherein the mechanical switch is configured controllably such that
in a first opening position the exhaust gas flows at least partially through the bypass pipe,
in a second opening position the exhaust gas flows at least partially through the exhaust gas cooler, and
in a closing position no exhaust gas flows through the exhaust gas recirculation device.

8. The exhaust gas recirculation device according to claim 7, wherein an actuator is provided for actuating the bypass switch, and the actuator is provided on the bypass switch or in the valve housing of the exhaust gas recirculation valve.

9. The exhaust recirculation device according to claim 8, wherein the actuator has at least one spring element for actuating the exhaust gas recirculation valve and/or the bypass switch.

10. The exhaust gas recirculation device according to claim 9, wherein the actuator is coupled by the at least one spring element to the bypass switch by spring resilience so that the bypass switch can be brought by spring resilience into the first opening position, into the second opening position and/or into the closing position.

11. The exhaust gas recirculation device according to claim 1, wherein a single control device is provided which controls both the function of the exhaust gas recirculation valve and of the bypass switch.

12. The exhaust gas recirculation device according to claim 11, wherein the control device is an electronic control device and is implemented in an engine control system.

13. The exhaust gas recirculation device according to claim 12, wherein the electronic control device generates a PWM control signal (XS) for controlling the exhaust gas recirculation valve and/or the bypass switch.

14. The exhaust gas recirculation device according to claim 11, wherein the control device is a mechanical control device which has an adjustable camshaft for controlling the exhaust gas recirculation valve and/or the bypass switch.

15. A vehicle comprising:
an internal combustion engine which has an exhaust outlet and a fresh air intake; and
an exhaust gas recirculation device according to claim 1,
wherein the exhaust gas recirculation device is connected on an exhaust side to the exhaust outlet and on a fresh air side to the fresh air intake, and
wherein the exhaust gas recirculation device is configured to add exhaust gas from the exhaust outlet to the fresh air (FL) at the fresh air intake.

16. The vehicle according to claim 15, wherein the exhaust gas recirculation device is connected on the exhaust side directly to an exhaust manifold of an engine block, and
wherein the exhaust gas recirculation is connected on the fresh air side to a common fresh air pipe which is connected downstream to the intake manifold of the engine block.
